(19) United States
(12) Patent Application Publication
(10) Pub. No.: US 2003/0138539 A1
(43) Pub. Date: Jul. 24, 2003

(54) Method for quickly producing made-to-order pizza

(76) Inventor: John W. Swanson, Portland, OR (US)

Correspondence Address: TIMOTHY E SIEGEL, 1868 KNAPPS ALLEY, SUITE 206, WEST LINN, OR, 97068, US

(21) Appl. No.: 10/054,565

(22) Filed: Jan. 22, 2002

(51) Int. Cl. A21D 10/00

(52) U.S. Cl. 426/549

(57) ABSTRACT

A method of preparing and selling made-to-order pizza. The method requires having a set of partially baked crusts available and having a location for customers to place orders. A set of partially baked crusts are covered with sauce and cheese, to create pizza blanks. Orders for pizza are received, each of which includes a specified set of toppings. In response to each order, the specified set of toppings is placed on one of the pizza blanks. The prepared blanks are placed in a rapid cook oven and permitted to remain for long enough to become cooked pizzas. The cooked pizzas are then removed from the rapid cook oven and delivered to the customers in return for payments.

### BACKGROUND OF THE INVENTION

Despite the enormous popularity of pizza, which has been demonstrated in many consumer polls, it has been left out of the fast food drive through revolution. It is quite likely that this is because, heretofore, there was no way of filling an order for freshly baked pizza, bearing a real time customer specified set of toppings, in a 1-4 minute time frame. As a result, drive through lanes and counter order and pick up restaurants have been dominated by hamburgers, fried chicken and Mexican style food. There can be little doubt that if pizza orders could be filled quickly enough to make a drive through system practical, it would be a commercial success.

Although the use of partially baked crusts and impingement ovens is known in the pizza business, such use has not resulted in the ability to fulfill orders in under 4 minutes. Also, although it is known to cook pizzas in ultraviolet ovens, this has not resulted in order fulfillment in under 4 minutes.

Accordingly, if pizza could be made-to-order in a 1-4 minute time frame, many commercial opportunities for the sale of made-to-order pizza would result.

### SUMMARY

In a first separate aspect, the present invention is a method of rapidly preparing a first pizza and a second pizza, each bearing a unique set of toppings in accordance with a first and second order respectively. First, sauce and cheese are placed on a first and a second partially baked crust, thereby creating a first and second pizza blank respectively. Then a first order is received for pizza bearing a first set of toppings, which is placed onto the first pizza blank to form a first topped blank. The first topped blank is then placed into an oven. Also, a second order is received for pizza bearing a second set of toppings, which is placed onto the second pizza blank to form a second topped blank. The second topped blank is placed into an oven. The first topped blank is permitted to remain in the oven for long enough to become a first cooked pizza and the second topped blank is also permitted to remain in the oven for long enough to become a second cooked pizza after. Finally, the first cooked pizza is removed from the oven and, likewise, the second cooked pizza is removed from the oven.

In a second separate aspect, the present invention is a method of preparing and selling made-to-order pizza that starts with a set of partially baked crusts and a location for customers to place orders. Next, a set of pizza blanks are prepared from a subset of the set of partially baked crusts by placing sauce and cheese on the subset of the set of partially baked crusts. Orders for pizza are received from the customers, each order including a specified set of toppings. In response to each order, the specified set of toppings is placed on the pizza blank to produce a toppings bearing pizza blank. Each toppings bearing pizza blank is placed into an oven and permitted to remain in the oven for long enough to become a cooked pizza. Then each cooked pizza is removed from the oven and the cooked pizzas are delivered to the customers. Additionally, payments are received from the customers in exchange for the cooked pizzas. The pizzas may be cut and boxed, although with individual sized pizzas, this may not be necessary.

In a third separate aspect, the present invention is a restaurant drive through lane, offering made-to-order pizza delivered within one to four minutes of receiving the order for the made-to-order pizza.

### DETAILED DESCRIPTION OF THE PREFERRED EMBODIMENT

The secret to quickly fulfilling a pizza order lies in two elements: using a partially baked (par-baked) crust and preparing a number of crusts ahead of receiving an order by placing sauce and cheese on them. In addition, a rapid cook oven, such as an impingement oven or an ultraviolet oven, greatly facilitates the speedy production of made-to-order pizza.

By fulfilling pizza orders quickly, a drive through lane at a pizza restaurant becomes truly practical. Traditionally, a drive through lane includes an outside menu board having a microphone and speaker pair so that a restaurant employee may take the customer's order. In addition a payment window is provided for receiving money from the customer and an order fulfillment window for delivering the food. For a small unit, or for off-peak hours, one or more windows may be unavailable. Ideally, there is a line of cars, so that it takes about 4 to 6 minutes for each car to get from the menu board to the order fulfillment window, thereby providing the workers with a brief amount of time to prepare the ordered food. In some instances, of course, there will not be a line of cars and the customer may have to wait for a brief period of time while his food is prepared.

To practice the present invention, pizza crust is made in the traditional manner, cooked until it is about 50% to 90% of the way done. The par-baked crusts are delivered daily from a central bakery to a set of fast food/drive through pizza outlets. Alternatively, the crusts may be prepared at an individual fast food/drive through pizza outlet.

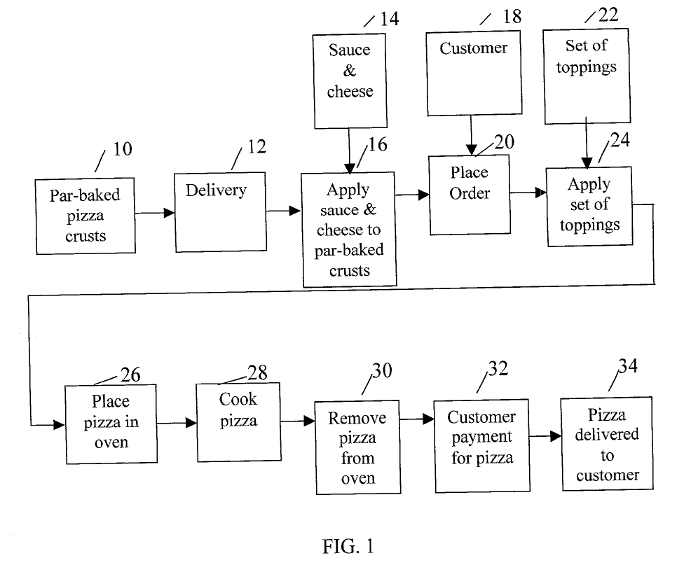

Referring to FIG. 1, a quantity of par-baked pizza crusts 10 may be delivered 12 before the start of the business day to a restaurant, and readied for use. An employee or group of employees could be assigned the task of accessing sauce and shredded cheese 14 and applying these items to the par-baked crusts 16, to form “pizza blanks” in advance of customer orders. Accordingly, whenever a customer 18 places an order 20 a pizza blank. These blanks can be kept until they are no longer useable, due to a prospective deterioration in the end product or by health regulations and then discarded if not used.

After a customer order is received a worker accesses a set of toppings 22, and places the customer specified set of toppings 24 onto the pizza blank.

After this the toppings blank is placed in an oven 26 and permitted to remain there until it becomes a cooked pizza 28. In one preferred embodiment an ultraviolet oven is used for cooking the pizza. This type of oven includes a top and bottom high intensity ultraviolet light source spaced about 25 cm (10 in) apart vertically. Such an oven is particularly well adapted for cooking par-baked crusts, which tend to agglutinate when cooked in a microwave oven, yielding a doughy, undesirable crust. By using such an oven the total bake time can be reduced to less than two minutes, thereby permitting up to two minutes for the pre and post bake preparation. Another type of oven that can be used in the process is an impingement oven, in which the pizza is placed on a conveyer belt that takes it between two closely spaced electric heating elements. Also, a very hot (>260° C.) convection oven could be used.

At this point the pizza is removed from the oven 30. The pizza may be an individual portion that does not need to be cut and may be simply wrapped in paper or placed sideways in a properly sized paper bag or other container and handed to the customer. Alternatively a standard 25 cm (10 inch) or 40.6 cm (16 in) pizza would be sliced and boxed prior to delivery to the customer. and delivered to a customer 32 in exchange for a payment 34.

In a preferred embodiment, a system for receiving orders and preparing made-to-order pizza is quite similar to what is found in many fast food burger restaurants today, offering both a drive through lane and a counter order system. The “sauce” mentioned frequently in this application would typically be a tomato sauce. Other sauces, such as pesto, could also be used. Also, various named combinations are offered on the menu board, such as “the works,” which would be sausage, bell peppers, onions and olives, with tomato sauce and cheese assumed.

Each received order would be displayed in the kitchen on display terminal. The chef would take a recently pasted and cheesed crust, place the remainder of the toppings on it and place it in the rapid cook oven for from 1 to 2 minutes, depending on the exact order and the oven used. After this, the pizza would be removed from the oven, cut packaged and delivered to the customer, either at the counter, by a waiter taking it to the customer's table, or at the drive through order delivery window. Shortly before or after the delivery of the pizza to the customer, the charge would be collected.

1. A method of rapidly preparing a first pizza and a second pizza, each bearing a unique set of toppings in accordance with a first and second order respectively, said method comprising:
(a) providing a first and a second partially baked crust;
(b) placing sauce and cheese on said first and second partially baked crusts to create a first pizza blank and a second pizza blank;
(c) after step (b) receiving a first order for a pizza bearing a first set of toppings;
(d) placing said first set of toppings onto said first pizza blank to form a first topped blank;
(e) placing said first topped blank into an oven;
(f) after step (b) receiving a second order for a pizza bearing a second set of toppings;
(g) placing said second set of toppings onto said second pizza blank to form a second topped blank;
(h) placing said second topped blank into an oven;
(i) permitting said first topped blank to remain in said oven for long enough to become a first cooked pizza;
(j) permitting said second topped blank to remain in said oven for long enough to become a second cooked pizza;
(k) removing said first cooked pizza from said oven
(l) removing said second cooked pizza from said oven.

2. The method of claim 1 in which said order is received from a drive through lane and said cooked pizza is delivered to a drive through lane window.

3. The method of claim 1 in which said topped blanks each have a top surface and a bottom surface and wherein said oven is an ultraviolet oven, in which high intensity sources of ultraviolet light are placed close to said top surface and said bottom surface.

4. The method of claim 1 in which said pizza is cooked in less than 3.5 minutes.

5. The method of claim 1 in which said pizza is cooked in less than 2.0 minutes.

6. The method of claim 1 in which said pizza is cut and packaged prior to being delivered to said customer.

7. A method of preparing and selling made-to-order pizza, comprising:
(a) providing a set of partially baked crusts;
(b) providing a location for customers to place orders;
(c) preparing a set of pizza blanks from a subset of said set of partially baked crusts by placing sauce and cheese on said subset of said set of partially baked crusts;
(d) receiving orders for pizza, each order including a specified a set of toppings;
(e) in response to each order, placing a said specified set of toppings on a said pizza blank to produce a toppings bearing pizza blank;
(f) placing each said toppings bearing pizza blank into an oven;
(g) permitting each said toppings bearing pizza blank to remain in said oven for long enough to become a cooked pizza;
(h) removing each said cooked pizza from said oven;
(i) receiving payments from said customers in exchange for said cooked pizzas; and
(j) delivering said cooked pizzas to said customers.

8. The method of claim 7 in which said orders are received from a drive through lane and said cooked pizzas are delivered to said customers at a drive through lane window.

9. The method of claim 7 in which said topped blanks each have a top surface and a bottom surface and wherein said oven is an ultraviolet oven, in which high intensity sources of ultraviolet light are placed close to said top surface and said bottom surface.

10. The method of claim 6 in which said pizza is cooked in less than 3.5 minutes.

11. The method of claim 7 in which said pizza is cooked in less than 2.0 minutes.

12. A restaurant comprising a drive through lane, offering made-to-order pizza delivered within four minutes of receiving an order for said made-to-order pizza.

13. The restaurant of claim 12 further comprising at least one ultraviolet oven for cooking said pizza.
